(19) United States
(12) Patent Application Publication
(10) Pub. No.: US 2026/0348781 A1
(43) Pub. Date: Nov. 5, 2026

(54) FLEXIBLE SIX-AXIS FORCE/TORQUE SENSING DEVICE, SYSTEM AND METHOD BASED ON U-SHAPED MICRO/NANOFIBER

(71) Applicant: SOUTHEAST UNIVERSITY, Jiangsu (CN)

(72) Inventors: Baoguo XU, Jiangsu (CN); Huan ZHU, Jiangsu (CN); Jiawei ZHANG, Jiangsu (CN); Huijun LI, Jiangsu (CN); Aiguo SONG, Jiangsu (CN)

(73) Assignee: SOUTHEAST UNIVERSITY, Jiangsu (CN)

(21) Appl. No.: 19/538,860

(22) Filed: Feb. 12, 2026

Related U.S. Application Data
(63) Continuation of application No. PCT/CN2025/090573, filed on Apr. 23, 2025.

(30) Foreign Application Priority Data
Apr. 2, 2025 (CN) 202510407699.1

(51) Int. Cl. G01L 5/166; G01L 1/24; G01L 3/08

(52) U.S. Cl. CPC G01L 5/166; G01L 1/242; G01L 3/08

(57) ABSTRACT

A flexible six-axis force/torque sensing device based on a U-shaped micro/nanofiber includes a flexible elastomer, a first U-shaped MNF, a second U-shaped MNF, a third U-shaped MNF, and a fourth U-shaped MNF. The flexible elastomer includes a floating beam at an edge of the flexible elastomer, a boss at a center of the flexible elastomer, and a first elastic beam, a second elastic beam, a third elastic beam, and a fourth elastic beam arranged between the boss and the floating beam.

### CROSS-REFERENCE TO RELATED APPLICATION

The present application is a continuation of PCT application No. PCT/CN2025/090573, filed on Apr. 23, 2025, which claims the priority of China Patent Application No. 202510407699.1, filed on Apr. 2, 2025. The entirety of each of the above-mentioned patent applications is incorporated by reference herein and made a part of this specification.

### TECHNICAL FIELD

The present disclosure relates to the force sensing technology, and in particular to a flexible six-axis force/torque sensing device, system and method based on a U-shaped micro/nanofiber.

### BACKGROUND

Multi-axis force sensors play a critical role in robotic grasping, manipulation, and human-robot interaction. Conventional rigid six-axis force/torque sensors are typically implemented using a rigid cross-beam structure; however, rigid sensors have limited application scenarios. Therefore, it is necessary to develop flexible multi-axis force sensors, which have wide application in flexible robotics, flexible electronic skin, and health monitoring. Flexible multi-axis force sensors are usually implemented by microstructures (such as pyramidal structures, hemispherical structures, and interdigitated structures). Normal force and shear force are measured through different deformations of these microstructures; however, these structures suffer from issues including signal crosstalk and structural complexity.

In recent years, optical sensors have been further developed, exhibiting characteristics such as high sensitivity, electrical passivity, and high resolution. Micro/nanofibers (MNFs) offer low transmission loss, high tensile strength, and compatibility with standard optical fibers. By detecting variations in optical intensity caused by mechanical loading on MNFs, a direction of applied force can be selected and determined. This method has the advantages of low signal crosstalk and a simple structure, enabling three-axis force measurement. For example, Chinese patent application No. 202411186846.9 discloses a flexible multi-axis force sensor and system based on tapered optical fibers. In this solution, one or more U-shaped MNFs are utilized to sense and measure multi-axis forces, including normal force and lateral shear force. However, this solution is only capable of three-axis force measurement, and cannot achieve three-axis torque measurement. Moreover, its sensitivity needs to be further improved.

### SUMMARY

In view of the problems existing in the prior art, objectives of the present disclosure are to provide a flexible six-axis force/torque sensing device, system and method based on a U-shaped micro/nanofiber, which are capable of realizing six-axis force/torque sensing with higher sensitivity.

In order to achieve the above objective, the present disclosure provides the following technical solutions:
a flexible six-axis force/torque sensing device based on a U-shaped micro/nanofiber includes a flexible elastomer, a first U-shaped micro/nanofiber (MNF), a second U-shaped MNF, a third U-shaped MNF, and a fourth U-shaped MNF, where the flexible elastomer includes a floating beam at an edge of the flexible elastomer, a boss at a center of the flexible elastomer, and a first elastic beam, a second elastic beam, a third elastic beam, and a fourth elastic beam arranged between the boss and the floating beam; the first elastic beam, the second elastic beam, the third elastic beam, and the fourth elastic beam are arranged at intervals of 90 degrees in a clockwise direction; the first U-shaped MNF and the second U-shaped MNF are respectively embedded in the first elastic beam and the second elastic beam along a longitudinal direction, and the third U-shaped MNF and the fourth U-shaped MNF are respectively embedded in the third elastic beam and the fourth elastic beam along a transverse direction; and a plane in which the first U-shaped MNF and the second U-shaped MNF are located is parallel to a surface of the flexible elastomer, and a plane in which the third U-shaped MNF and the fourth U-shaped MNF are located is perpendicular to the surface of the flexible elastomer.

Further, each of the first elastic beam, the second elastic beam, the third elastic beam, and the fourth elastic beam has one end connected to the floating beam, and the other end of each of the elastic beams is connected to the boss; and a height of a lower surface at a connection portion between each of the first elastic beam, the second elastic beam, the third elastic beam, the fourth elastic beam, and the boss is higher than a lower surface of the boss.

Further, U-shaped heads of the first U-shaped MNF and the second U-shaped MNF are respectively arranged proximal to the boss, and fiber input ends and fiber output ends thereof respectively extend out of the first elastic beam and the second elastic beam.

Further, the third U-shaped MNF and the fourth U-shaped MNF are arranged proximal to the boss as a whole, and fiber input ends and fiber output ends thereof respectively extend out of the third elastic beam and the fourth elastic beam.

Further, the flexible elastomer is made of a polydimethylsiloxane (PDMS) material.

A flexible six-axis force/torque sensing system based on a U-shaped micro/nanofiber includes the above-mentioned flexible six-axis force/torque sensing device based on a U-shaped micro/nanofiber, and further includes a laser, a photodetector, and a computing module; wherein the laser is connected, via optical fibers, to fiber input ends of a first U-shaped MNF, a second U-shaped MNF, a third U-shaped MNF, and a fourth U-shaped MNF, respectively; the photodetector is connected, via optical fibers, to fiber output ends of the first U-shaped MNF, the second U-shaped MNF, the third U-shaped MNF, and the fourth U-shaped MNF, respectively; and the computing module is configured to calculate three-axis forces and three-axis torques based on optical signals detected by the photodetector after a force/torque is applied to the boss.

Further, the computing module is configured to calculate three-axis forces and three-axis torques according to the following formulas:

$${F}_{x} = {f}_{1} ( Δ {I}_{3} )$$

$${F}_{y} = {f}_{2} ( Δ {I}_{4} )$$

$${F}_{z} = {f}_{3} ( \frac{Δ {I}_{1} + Δ {I}_{2}}{2} )$$

$${M}_{x} = {f}_{4} ( Δ {I}_{1} )$$

$${M}_{y} = {f}_{5} ( Δ {I}_{2} )$$

$${M}_{z} = {f}_{6} ( \frac{Δ {I}_{3} + Δ {I}_{4}}{2} )$$

where Fₓ, F_{y} and F_{z} respectively denote force components of the three-axis force in the x, y and z directions; Mₓ, M_{y} and M_{z} respectively denote torque components of the three-axis torque in the x, y and z directions; ƒ₁, ƒ₂, ƒ₃, ƒ₄, ƒ₅ and ƒ₆ respectively denote relationship functions between Fₓ and F_{y}, F_{z}, M_{y}, M_{y}, M_{z} and changes in optical intensities; ΔI₁=I₁−I₁₀, ΔI₂=I₂−I₂₀, ΔI₃=I₃−I₃₀ and ΔI₄=I₄−I₄₀ respectively denote changes in optical intensities of the first U-shaped MNF, the second U-shaped MNF, the third U-shaped MNF, and the fourth U-shaped MNF when a force is applied; I₁₀, I₂₀, I₃₀ and I₄₀ respectively denote optical intensities at fiber output ends of the first U-shaped MNF, the second U-shaped MNF, the third U-shaped MNF, and the fourth U-shaped MNF when no force is applied; and I₁, I₂, I₃ and I₄ respectively denote optical intensities at fiber output ends of the first U-shaped MNF, the second U-shaped MNF, the third U-shaped MNF, and the fourth U-shaped MNF when a force is applied.

Further, the relationship functions ƒ₁, ƒ₂, ƒ₃, ƒ₄, ƒ₅ and ƒ₆ are obtained through the following method:
recording changes in the optical intensities at the fiber output ends of the first U-shaped MNF, the second U-shaped MNF, the third U-shaped MNF, and the fourth U-shaped MNF when different known force/torque values are applied to the boss, and performing fitting based on the changes in optical intensities and corresponding known force/torque data to obtain the relationship functions ƒ₁, ƒ₂, ƒ₃, ƒ₄, ƒ₅ and ƒ₆.

A flexible six-axis force/torque sensing method based on a U-shaped micro/nanofiber is provided. The method is implemented through the above-mentioned flexible six-axis force/torque sensing device based on a U-shaped micro/nanofiber, and includes:
inputting laser light to fiber input ends of a first U-shaped MNF, a second U-shaped MNF, a third U-shaped MNF, and a fourth U-shaped MNF; and
calculating three-axis forces and three-axis torques of optical signals at fiber output ends of the first U-shaped MNF, the second U-shaped MNF, the third U-shaped MNF, and the fourth U-shaped MNF after a force/torque is applied to the boss.

Further, the three-axis forces and the three-axis torques are calculated according to the following formulas:

$${F}_{x} = {f}_{1} ( Δ {I}_{3} )$$

$${F}_{y} = {f}_{2} ( Δ {I}_{4} )$$

$${F}_{z} = {f}_{3} ( \frac{Δ {I}_{1} + Δ {I}_{2}}{2} )$$

$${M}_{x} = {f}_{4} ( Δ {I}_{1} )$$

$${M}_{y} = {f}_{5} ( Δ {I}_{2} )$$

$${M}_{z} = {f}_{6} ( \frac{Δ {I}_{3} + Δ {I}_{4}}{2} )$$

where Fₓ and F_{y}, F_{z} respectively denote force components of a three-axis force in x, y and z directions; M_{y}, M_{y} and M_{z} respectively denote components of a three-axis torque in the x, y and z directions; ƒ₁, ƒ₂, ƒ₃, ƒ₄, ƒ₅ and ƒ₆ respectively denote relationship functions between Fₓ, F_{y}, F_{z}, Mₓ, M_{y}, M_{z} and changes in optical intensity; ΔI₁=I₁−I₁₀, ΔI₂=I₂−I₂₀, ΔI₃=I₃−I₃₀ and ΔI₄=I₄−I₄₀ respectively denote changes in optical intensities of the first U-shaped MNF, the second U-shaped MNF, the third U-shaped MNF, and the fourth U-shaped MNF when a force is applied; I₁₀, I₂₀, I₃₀ and I₄₀ respectively denote optical intensities at fiber output ends of the first U-shaped MNF, the second U-shaped MNF, the third U-shaped MNF, and the fourth U-shaped MNF when no force is applied; and I₁, I₂, I₃ and I₄ respectively denote optical intensities at fiber output ends of the first U-shaped MNF, the second U-shaped MNF, the third U-shaped MNF, and the fourth U-shaped MNF when a force is applied.

Compared with the prior art, the present disclosure has the beneficial effects:
1. By combining a flexible elastomer with U-shaped MNF, magnitudes of force/torques are obtained based on changes in optical intensities of four U-shaped MNFs. Directions of the applied force/torque are determined according to changes in optical intensities of U-shaped MNFs with different reference indices, thereby realizing six-axis force/torque measurement.
2. Based on the photoelastic effect of PDMS, when an elastic beam is subjected to an external force and undergoes deformation, the local refractive index at the deformed region changes, such that the conditions for total internal reflection are locally no longer satisfied, and the propagation direction of reflected light is thus changed. Macroscopically, radiation light is generated at the deformed region, leading to changes in the optical intensities at the output end. Magnitudes of the six-axis force/torque are measured according to the changes in the optical intensities.
3. By arranging the four U-shaped MNFs at unique positions within the four elastic beams, a degree of deformation is increased, thereby improving sensitivity.
4. Compared with conventional rigid six-axis force/torque sensing devices, the present disclosure realizes anisotropy through the U-shaped MNFs, thereby enabling selective force measurement directions. Furthermore, by embedding the U-shaped MNF with different orientations into different elastic beams, six-axis force/torque measurement is achieved, thereby reducing crosstalk and coupling among the six-axis force/torques.
5. The flexible elastomer adopted in the present disclosure is simple to manufacture and low in cost.
6. The present disclosure enables miniaturization of the sensors through improvements in manufacturing processes, and exhibits electrical passivity and biocompatibility, allowing it to be integrated into minimally invasive surgical instruments and thus applicable to a wide range of scenarios.

### BRIEF DESCRIPTION OF THE DRAWINGS

FIG. 1 is a schematic structural diagram of a flexible six-axis force/torque sensing device based on a U-shaped micro/nanofiber according to an embodiment of the present disclosure.

FIG. 2 is a schematic structural diagram of a flexible six-axis force/torque sensing system based on a U-shaped micro/nanofiber according to an embodiment of the present disclosure.

FIG. 3 is a schematic diagram of a heating-tapered stretching method.

FIG. 4 is a schematic diagram illustrating first and second U-shaped MNFs \textcircled{1} and \textcircled{2} embedded in elastic beams in a top view of a flexible elastomer.

FIG. 5 is a schematic diagram illustrating third and fourth U-shaped MNFs \textcircled{3} and \textcircled{4} embedded in elastic beams in a side view of a flexible elastomer.

FIG. 6 is a schematic diagram illustrating deformation of elastic beams and U-shaped MNFs when a boss is subjected to a force in a z direction.

FIG. 7 is a schematic diagram illustrating deformation of elastic beams and U-shaped MNFs when a boss is subjected to a force in an x direction.

FIG. 8 is a schematic diagram illustrating deformation of elastic beams and U-shaped MNFs when a boss is subjected to a force in a y direction.

FIG. 9 is a schematic diagram illustrating deformation of elastic beams and U-shaped MNFs when a boss is subjected to a torque in a z direction.

FIG. 10 is a schematic diagram illustrating deformation of elastic beams and U-shaped MNFs when a boss is subjected to a torque in an x direction.

FIG. 11 is a schematic diagram illustrating deformation of elastic beams and U-shaped MNFs when a boss is subjected to a torque in a y direction.

### DETAILED DESCRIPTIONS OF THE EMBODIMENTS

The technical solutions of embodiments of the present disclosure will be described below clearly and comprehensively with reference to accompanying drawings of the embodiments of the present disclosure.

### Embodiment 1

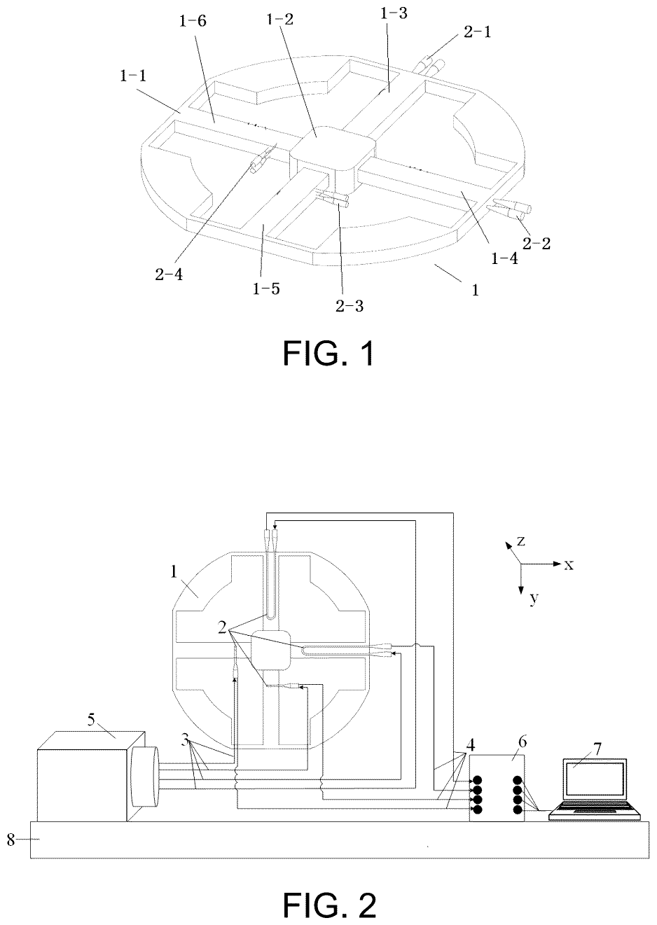

An embodiment of the present disclosure provides a flexible six-axis force/torque sensing device based on a U-shaped micro/nanofiber. As shown in FIGS. 1 and 2, the device includes a flexible elastomer 1 and four U-shaped MNFs 2 (including a first U-shaped MNF 2-1, a second U-shaped MNF 2-2, a third U-shaped MNF 2-3, and a fourth U-shaped MNF 2-4). Specifically, the flexible elastomer 1 is made of a polydimethylsiloxane (PDMS) material. The flexible elastomer 1 includes a floating beam 1-1 at an edge of the flexible elastomer, a boss 1-2 at a center, and a first elastic beam 1-3, a second elastic beam 1-4, a third elastic beam 1-5, and a fourth elastic beam 1-6 arranged between the boss 1-2 and the floating beam 1-1. The first elastic beam 1-3, the second elastic beam 1-4, the third elastic beam 1-5, and the fourth elastic beam 1-6 are arranged at intervals of 90 degrees in a clockwise direction. The first U-shaped MNF 2-1 and the second U-shaped MNF 2-2 are respectively embedded in the first elastic beam 1-3 and the second elastic beam 1-4 along a longitudinal direction. The third U-shaped MNF 2-3 and the fourth U-shaped MNF 2-4 are respectively embedded in the third elastic beam 1-5 and the fourth elastic beam 1-6 along a transverse direction. A plane in which the first U-shaped MNF 2-1 and the second U-shaped MNF 2-2 are located is parallel to a surface of the flexible elastomer 1, and a plane in which the third U-shaped MNF 2-3 and the fourth U-shaped MNF 2-4 are located is perpendicular to the surface of the flexible elastomer 1. By arranging the elastic beams, a deformation force generated after displacement of the boss can be obtained, thereby improving sensitivity. In addition, the unique positional arrangement of the four U-shaped MNFs enables the six-axis force/torque measurement.

Specifically, each of the first elastic beam 1-3, the second elastic beam 1-4, the third elastic beam 1-5, and the fourth elastic beam 1-6 has one end connected to the floating beam 1-1, and the other end of each of the elastic beams is connected to the boss 1-2. Furthermore, a height of a lower surface at a connection portion between each of the first elastic beam 1-3, the second elastic beam 1-4, the third elastic beam 1-5, the fourth elastic beam 1-6, and the boss 1-2 is higher than a lower surface of the boss 1-2, such that deformation of the first elastic beam 1-3, the second elastic beam 1-4, the third elastic beam 1-5, and the fourth elastic beam 1-6 under an applied force on the boss 1-2 may be increased, thereby further improving sensitivity.

Specifically, U-shaped heads of the first U-shaped MNF 2-1 and the second U-shaped MNF 2-2 are respectively arranged proximal to the boss 1-2, and fiber input ends and fiber output ends thereof respectively extend out of the first elastic beam 1-3 and the second elastic beam 1-4. The third U-shaped MNF 2-3 and the fourth U-shaped MNF 2-4 are arranged proximal to the boss 1-2 as a whole, and fiber input ends and fiber output ends thereof respectively extend out of the third elastic beam 1-5 and the fourth elastic beam 1-6. Accordingly, optical fibers can be connected at the fiber input ends and the fiber output ends to input optical signals and measure output optical signals.

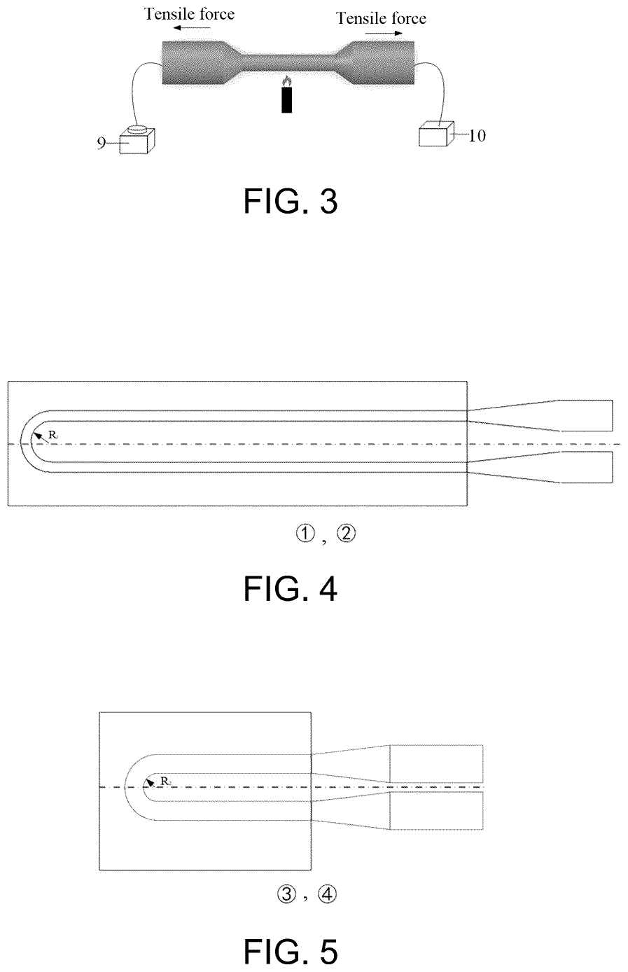

A manufacturing process of the U-shaped MNF is as follows: a commercially available single-mode SiO₂ optical fiber is used as a starting material. SiO₂ MNF is fabricated using a tapered stretching technique, as shown in FIG. 3. First, the optical fiber is heated to a temperature exceeding a softening point of quartz glass. Under the control of a high-precision translation stage, the optical fiber is bidirectionally stretched at a constant speed (0.1 mm/s). During the stretching process, a 785 nm laser source 9 and a power meter 10 are connected to two ends of the optical fiber to monitor transmission characteristics in real time. When an optical intensity at the output end suddenly decreases (due to cutoff of higher-order modes), stretching is stopped, thereby enabling precise control of a diameter of the U-shaped MNF. In this embodiment, the diameter of the U-shaped MNF is 2 μm. Specific steps of fabricating the flexible elastomer using a parallel capillary confinement method are as follows: two parallel glass capillary molds are used, and a spacing (L0) between the glass capillaries determines a separation distance between fiber ends, thereby determining a bending radius (Rb≈L0/2) of the U-shaped MNF. The optical fiber is passed through the capillaries. A layer of PDMS solution (by mixing a base component and a curing agent of Dow Corning DC184 at a ratio of 10:1) is drop-coated onto a bottom layer of each mold for the flexible elastomer to form a substrate layer. The U-shaped MNF fixed in the capillaries is placed on the elastic beam substrate layer and bonded to the PDMS substrate layer using an adhesive. After curing, the glass capillary molds are removed, and another layer of PDMS solution is applied. The structure is then cured by baking at 40 °C for 10 h. Finally, the flexible elastomer is gently separated from the molds using a release agent, thereby obtaining a flexible elastomer with four embedded U-shaped MNFs.

The main sensing principle of the present disclosure is as follows: the first U-shaped MNF 2-1, the second U-shaped MNF 2-2, the third U-shaped MNF 2-3, and the fourth U-shaped MNF 2-4 are respectively labeled as U-shaped MNFs \textcircled{1}, \textcircled{2}, \textcircled{3}, and \textcircled{4}. When an external force is applied to the boss of the flexible elastomer, the elastic beams of the flexible elastomer deform. Due to the photoelastic effect of PDMS, a local refractive index at a deformation position changes, causing the U-shaped MNF to transition from a guided mode to a radiation mode. Consequently, an optical intensity at an output end of the U-shaped MNF changes. Force values and torque magnitudes are calculated based on changes in the optical intensity. Due to different distribution configurations of the four U-shaped MNFs, specifically, as shown in FIG. 4, centerlines of the first and second U-shaped MNFs \textcircled{1} and \textcircled{2}, are parallel to a longitudinal axis of the elastic beams. As shown in FIG. 5, centerlines of the third and fourth U-shaped MNFs \textcircled{3} and \textcircled{4} are perpendicular to the longitudinal axis of the elastic beams. Obviously, due to inherent anisotropy of the U-shaped MNFs, their responses to forces/torques applied in different directions are also different. Two cases are considered: first, when an applied force/torque is perpendicular to a surface in which the U-shaped MNFs are located, the U-shaped MNFs exhibit sensitivity to the applied force/torque. Second, when an applied force/torque is parallel to the surface in which the U-shaped MNFs are located, the U-shaped MNF is sensitive to force/torque components parallel to the centerlines of the U-shaped MNFs, and insensitive to force/torque components perpendicular to the centerlines of the U-shaped MNFs. The four MNFs are embedded in a way that generates different responses to forces/torques applied in different directions, thereby enabling the determination of force/torque directions.

### Embodiment 2

An embodiment of the present disclosure further provides a flexible six-axis force/torque sensing system based on a U-shaped micro/nanofiber, which includes the above-mentioned flexible six-axis force/torque sensing device based on a U-shaped micro/nanofiber, and further includes a laser 5, a photodetector 6, and a computing module 7. The laser 5, the photodetector 6, and the computing module 7 are all disposed on a base 8. The laser is respectively connected, via optical fibers 3, to fiber input ends of the first U-shaped MNF 2-1, the second U-shaped MNF 2-2, the third U-shaped MNF 2-3, and the fourth U-shaped MNF 2-4. The photodetector is respectively connected, via optical fibers 4, to fiber output ends of the first U-shaped MNF 2-1, the second U-shaped MNF 2-2, the third U-shaped MNF 2-3, and the fourth U-shaped MNF 2-4. The computing module is configured to calculate three-axis forces and three-axis torques based on optical signals detected by the photodetector after a force/torque is applied to the boss 1-2.

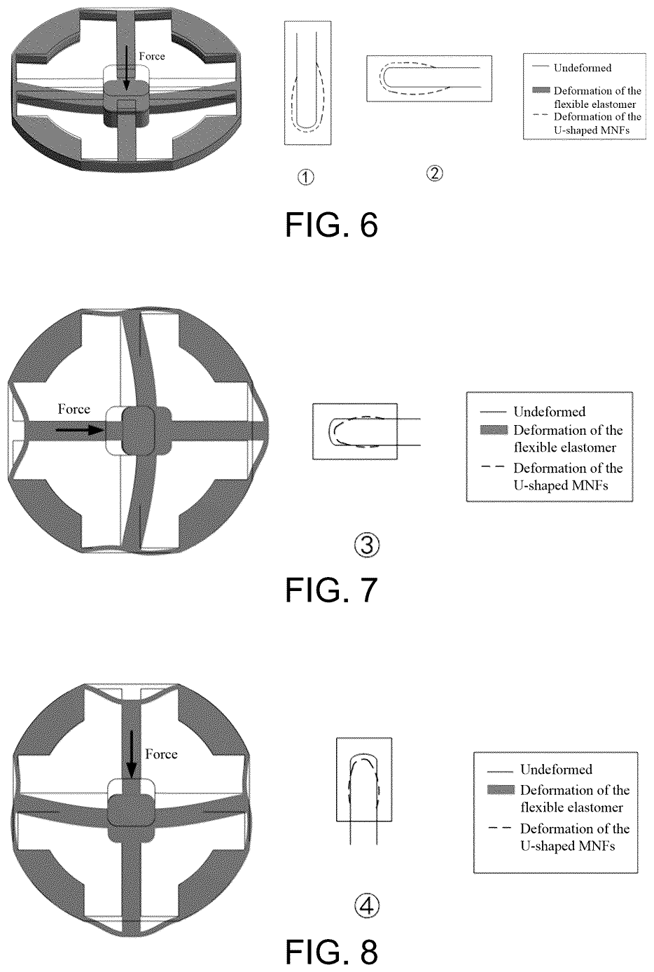

As shown in FIG. 6, when a force in a z direction is applied to the boss, the force in the z direction is perpendicular to the centerlines of U-shaped MNFs \textcircled{3} and \textcircled{4}, and perpendicular to the surface in which U-shaped MNFs \textcircled{1} and \textcircled{2} are located. As a result, optical intensities at the output ends of U-shaped MNFs \textcircled{1} and \textcircled{2} change, while changes in the optical intensities at the output ends of U-shaped MNFs \textcircled{3} and \textcircled{4} are very small. Furthermore, since changes in the optical intensities of U-shaped MNFs \textcircled{1} and \textcircled{2} are the same, the following expression is obtained:

$${F}_{z} = {f}_{3} ( \frac{Δ {I}_{1} + Δ {I}_{2}}{2} )$$

As shown in FIG. 7, when a force in an x direction is applied to the boss, the force in the x direction is parallel to the centerline of U-shaped MNF \textcircled{3}. Change in an optical intensity of U-shaped MNF \textcircled{3} is taken as a characteristic parameter to solve the force in the x direction, thereby obtaining the following expression:

Fₓ=ƒ₁(ΔI₃)

As shown in FIG. 8, when a force in a y direction is applied to the boss, the force in the y direction is parallel to the centerline of U-shaped MNF \textcircled{4}. Change in an optical intensity of U-shaped MNF \textcircled{4} is taken as a characteristic parameter to solve the force in the y direction, thereby obtaining the following expression:

F_{y}=ƒ₂(ΔI₄)

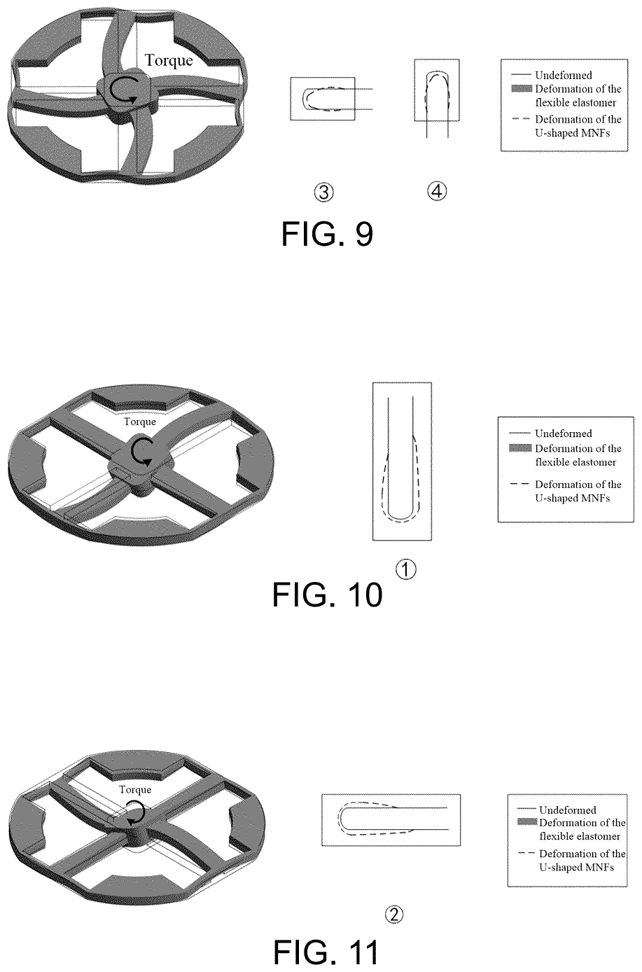

As shown in FIG. 9, when a torque in the z direction is applied to the boss, the torque in the z direction is perpendicular to the centerlines of U-shaped MNFs \textcircled{1} and \textcircled{2}, and is parallel to centerlines of U-shaped MNFs \textcircled{3} and \textcircled{4}. As a result, optical intensities at the output ends of U-shaped MNFs \textcircled{3} and \textcircled{4} change, while changes in the optical intensities at the output ends of U-shaped MNFs \textcircled{1} and \textcircled{2} are very small. Furthermore, since changes in the optical intensities of U-shaped MNFs \textcircled{3} and \textcircled{4} are consistent, the following expression is obtained:

$${M}_{z} = {f}_{6} ( \frac{Δ {I}_{3} + Δ {I}_{4}}{2} )$$

As shown in FIG. 10, when a torque in the x direction is applied to the boss, the torque in the x direction is perpendicular to a plane in which U-shaped MNF \textcircled{1} is located. Change in an optical intensity of U-shaped MNF \textcircled{1} is taken as a characteristic parameter to solve the torque in the x direction, thereby obtaining the following expression:

Mₓ=ƒ₄(ΔI₁)

As shown in FIG. 11, when a torque in the y direction is applied to the boss, the torque in the y direction is perpendicular to a plane in which U-shaped MNF \textcircled{2} is located. Change in an optical intensity of U-shaped MNF \textcircled{2} is taken as a characteristic parameter to solve the torque in the y direction, thereby obtaining the following expression:

M_{y}=ƒ₅(ΔI₂)
where ΔI₁=I₁−I₁₀, ΔI₂=I₂−I₂₀, ΔI₃=I₃−I₃₀ and ΔI₄=I₄−I₄₀. In FIGS. 6-11, the black solid lines represent positions of the flexible elastomer and the U-shaped MNFs before deformation, the gray solid blocks represent a position of the flexible elastomer after deformation, and the black dashed lines represent positions of the U-shaped MNFs after deformation.

In the above expressions, Fₓ, F_{y} and F_{z} respectively denote force components of a three-axis force in the x, y, z directions; M_{y}, M_{y} and M_{z} respectively denote components of a three-axis torque in the x, y, z directions; ƒ₁, ƒ₂, ƒ₃, ƒ₄, ƒ₅ and ƒ₆ respectively denote relationship function between Fₓ, F_{y}, F_{z}, Mₓ, M_{y}, M_{z} and changes in optical intensity; ΔI₁, ΔI₂, ΔI₃ and ΔI₄ respectively denote changes in optical intensities of the first U-shaped MNF, the second U-shaped MNF, the third U-shaped MNF, and the fourth U-shaped MNF; I₁₀, I₂₀, I₃₀ and I₄₀ respectively denote optical intensities at fiber output ends of the first U-shaped MNF, the second U-shaped MNF, the third U-shaped MNF, and the fourth U-shaped MNF when no six-axis force/torque is applied; and I₁, I₂, I₃ and I₄ respectively denote optical intensities at the fiber output ends of the first U-shaped MNF, the second U-shaped MNF, the third U-shaped MNF, and the fourth U-shaped MNF when a force is applied. From the above expressions, it can also be seen that when different forces/torques are applied, directions of the six-axis force/torque may be determined by identifying which one or which two of the labeled U-shaped MNFs exhibit changes in optical intensity.

To obtain expressions of ƒ₁, ƒ₂, ƒ₃, ƒ₄, ƒ₅ and ƒ₆, changes in the optical intensities at the fiber output ends of the first U-shaped MNF, the second U-shaped MNF, the third U-shaped MNF, and the fourth U-shaped MNF are recorded when different known force/torque values are applied to the boss 1-2. Based on the changes in optical intensities and corresponding known force/torque data, fitting is performed to obtain the relationship functions ƒ₁, ƒ₂, ƒ₃, ƒ₄, ƒ₅ and ƒ₆.

The changes in optical intensities of the four U-shaped MNFs are recorded using a multi-channel photodetector. The multi-channel photodetector transmits the optical intensities at the output ends to the computing module through an acquisition board. In this embodiment, the acquisition board operates at a frequency of 500 Hz.

A calculation formula for optical transmission loss is expressed as:

$$α = 10 {log}_{10} ( \frac{I}{{I}_{0}} )$$

where I denotes an optical intensity under applied force/torque, and I₀ denotes an optical intensity without applied force/torque.

In the computing module, noise processing is performed on acquired signals to remove background noise and interference. In addition, signals from multiple measurements are averaged to improve measurement accuracy.

With respect to environmental control during measurement of the six-axis force/torque sensing device, since the changes in optical intensity at the output end are determined by the difference between optical intensity under applied force/torque and reference optical intensity, stability of the laser output affects the measurement results. In this embodiment, control is implemented from two aspects, that is, vibration isolation and light source. Specifically, the device is installed on a platform with vibration isolation measures; a laser with strong stability is used during experiments to reduce the impact of unstable light source on the experimental results.

It should be noted that, in the above embodiment of the system, various units and modules included are divided only according to functional logic, and are not limited to the divisions described above, as long as corresponding functions can be achieved. In addition, specific names of the functional units are provided only for ease of distinction and are not intended to limit the scope of protection of the present disclosure.

The embodiments described above are merely illustrative, where modules described as separate components may or may not be physically separated, and components shown as modules may or may not be physical modules, that is, they may be located at a single location or distributed across multiple network modules. Some or all of the modules may be selected according to actual needs to achieve the objectives of the embodiments. Those skilled in the art will clearly understand that various embodiments can be implemented using software in combination with necessary general-purpose hardware platforms, or can be implemented solely using hardware, as long as the corresponding functions or effects can be achieved.

### Embodiment 3

An embodiment of the present disclosure provides a flexible six-axis force/torque sensing method based on a U-shaped micro/nanofiber. The method is implemented through the flexible six-axis force/torque sensing device based on a U-shaped micro/nanofiber as described in Embodiment 1, and includes:
inputting laser light to fiber input ends of the first U-shaped MNF 2-1, the second U-shaped MNF 2-2, the third U-shaped MNF 2-3, and the fourth U-shaped MNF 2-4; and
calculating three-axis forces and three-axis torques of optical signals at fiber output ends of the first U-shaped MNF 2-1, the second U-shaped MNF 2-2, the third U-shaped MNF 2-3, and the fourth U-shaped MNF 2-4 after a force/torque is applied to the boss 1-2.

Specifically, the three-axis forces and the three-axis torques are calculated according to the following formulas:

$${F}_{x} = {f}_{1} ( Δ {I}_{3} )$$

$${F}_{y} = {f}_{2} ( Δ {I}_{4} )$$

$${F}_{z} = {f}_{3} ( \frac{Δ {I}_{1} + Δ {I}_{2}}{2} )$$

$${M}_{x} = {f}_{4} ( Δ {I}_{1} )$$

$${M}_{y} = {f}_{5} ( Δ {I}_{2} )$$

$${M}_{z} = {f}_{6} ( \frac{Δ {I}_{3} + Δ {I}_{4}}{2} )$$

where Fₓ, F_{y} and F_{z} respectively denote force components of a three-axis force in the x, y and z directions; Mₓ, M_{y} and M_{z} respectively denote components of a three-axis torque in the x, y and z directions; ƒ₁, ƒ₂, ƒ₃, ƒ₄, ƒ₅ and ƒ₆ respectively denote relationship functions between Fₓ, F_{y}, F_{z}, Mₓ, M_{y} and M_{z} and changes in optical intensity; ΔI₁=I₁−I₁₀, ΔI₂=I₂−I₂₀, ΔI₃=I₃−I₃₀ and ΔI₄=I₄−I₄₀ respectively denote changes in optical intensities of the first U-shaped MNF 2-1, the second U-shaped MNF 2-2, the third U-shaped MNF 2-3, and the fourth U-shaped MNF 2-4 when a force is applied; I₁₀, I₂₀, I₃₀ and I₄₀ respectively denote optical intensities at fiber output ends of the first U-shaped MNF 2-1, the second U-shaped MNF 2-2, the third U-shaped MNF 2-3, and the fourth U-shaped MNF 2-4 when no force is applied; and I₁, I₂, I₃, I₄ respectively denote optical intensities at fiber output ends of the first U-shaped MNF 2-1, the second U-shaped MNF 2-2, the third U-shaped MNF 2-3, and the fourth U-shaped MNF 2-4 when a force is applied.

It should be understood that the above embodiments and specification illustrate only the principles, main features, and advantages of the present disclosure. Various modifications and improvements may be made to the present disclosure without departing from the spirit and scope thereof, and such modifications and improvements shall fall within the scope of protection of the present disclosure.

What is claimed is:

1. A flexible six-axis force/torque sensing device based on a U-shaped micro/nanofiber, comprising a flexible elastomer, a first U-shaped micro/nanofiber (MNF), a second U-shaped MNF, a third U-shaped MNF, and a fourth U-shaped MNE, wherein the flexible elastomer comprises a floating beam at an edge of the flexible elastomer, a boss at a center of the flexible elastomer, and a first elastic beam, a second elastic beam, a third elastic beam, and a fourth elastic beam arranged between the boss and the floating beam; the first elastic beam, the second elastic beam, the third elastic beam, and the fourth elastic beam are arranged at intervals of 90 degrees in a clockwise direction; the first U-shaped MNF and the second U-shaped MNF are respectively embedded in the first elastic beam and the second elastic beam along a longitudinal direction, and the third U-shaped MNF and the fourth U-shaped MNF are respectively embedded in the third elastic beam and the fourth elastic beam along a transverse direction; and a plane in which the first U-shaped MNF and the second U-shaped MNF are located is parallel to a surface of the flexible elastomer, and a plane in which the third U-shaped MNF and the fourth U-shaped MNF are located is perpendicular to the surface of the flexible elastomer.

2. The flexible six-axis force/torque sensing device based on the U-shaped micro/nanofiber according to claim 1, wherein each of the first elastic beam, the second elastic beam, the third elastic beam, and the fourth elastic beam has one end connected to the floating beam, and an other end of each of the elastic beams is connected to the boss; and a height of a lower surface at a connection portion between each of the first elastic beam, the second elastic beam, the third elastic beam, the fourth elastic beam, and the boss is higher than a lower surface of the boss.

3. The flexible six-axis force/torque sensing device based on the U-shaped micro/nanofiber according to claim 1, wherein U-shaped heads of the first U-shaped MNF and the second U-shaped MNF are respectively arranged proximal to the boss, and fiber input ends and fiber output ends respectively extend out of the first elastic beam and the second elastic beam.

4. The flexible six-axis force/torque sensing device based on the U-shaped micro/nanofiber according to claim 1, wherein the third U-shaped MNF and the fourth U-shaped MNF are arranged proximal to the boss as a whole, and fiber input ends and fiber output ends respectively extend out of the third elastic beam and the fourth elastic beam.

5. The flexible six-axis force/torque sensing device based on the U-shaped micro/nanofiber according to claim 1, wherein the flexible elastomer is made of a polydimethylsiloxane (PDMS) material.

6. A flexible six-axis force/torque sensing system based on the U-shaped micro/nanofiber, comprising the flexible six-axis force/torque sensing device based on the U-shaped micro/nanofiber according to claim 1, and further comprising a laser, a photodetector, and a computing module; wherein the laser is connected, via optical fibers, to fiber input ends of the first U-shaped MNF, the second U-shaped MNF, the third U-shaped MNF, and the fourth U-shaped MNF, respectively; the photodetector is connected, via optical fibers, to fiber output ends of the first U-shaped MNF, the second U-shaped MNF, the third U-shaped MNF, and the fourth U-shaped MNF, respectively; and the computing module is configured to calculate three-axis forces and three-axis torques based on optical signals detected by the photodetector after a force/torque is applied to the boss.

7. The flexible six-axis force/torque sensing system based on the U-shaped micro/nanofiber according to claim 6, wherein the computing module is configured to calculate the three-axis forces and the three-axis torques according to the following formulas:
$${F}_{x} = {f}_{1} ( Δ {I}_{3} )$$
$${F}_{y} = {f}_{2} ( Δ {I}_{4} )$$
$${F}_{z} = {f}_{3} ( \frac{Δ {I}_{1} + Δ {I}_{2}}{2} )$$
$${M}_{x} = {f}_{4} ( Δ {I}_{1} )$$
$${M}_{y} = {f}_{5} ( Δ {I}_{2} )$$
$${M}_{z} = {f}_{6} ( \frac{Δ {I}_{3} + Δ {I}_{4}}{2} )$$
wherein Fₓ, F_{y} and F_{z} respectively denote force components of the three-axis forces in x, y and z directions; Mₓ, M_{y} and M_{z} respectively denote torque components of the three-axis torques in the x, y and z directions; ƒ₁, ƒ₂, ƒ₃, ƒ₄, ƒ₅ and ƒ₆ respectively denote relationship functions between Fₓ and F_{y}, F_{z}, M_{y}, M_{y}, M_{z} and changes in optical intensities; ΔI₁=I₁−I₁₀, ΔI₂−I₂−I₂₀, ΔI₃=I₃−I₃₀ and ΔI₄=I₄−I₄₀ respectively denote changes in optical intensities of the first U-shaped MNF, the second U-shaped MNF, the third U-shaped MNF, and the fourth U-shaped MNF when the force is applied; I₁₀, I₂₀, I₃₀ and I₄₀ respectively denote optical intensities at the fiber output ends of the first U-shaped MNF, the second U-shaped MNF, the third U-shaped MNF, and the fourth U-shaped MNF when no force is applied; and I₁, I₂, I₃ and I₄ respectively denote optical intensities at the fiber output ends of the first U-shaped MNF, the second U-shaped MNF, the third U-shaped MNF, and the fourth U-shaped MNF when the force is applied.

8. The flexible six-axis force/torque sensing system based on the U-shaped micro/nanofiber according to claim 7, wherein the relationship functions ƒ₁, ƒ₂, ƒ₃, ƒ₄, ƒ₅ and ƒ₆ are obtained through the following method:
recording the changes in the optical intensities at the fiber output ends of the first U-shaped MNF, the second U-shaped MNF, the third U-shaped MNF, and the fourth U-shaped MNF when different known force/torque values are applied to the boss, and performing fitting based on the changes in optical intensities and corresponding known force/torque data to obtain the relationship functions ƒ₁, ƒ₂, ƒ₃, ƒ₄, ƒ₅ and ƒ₆.

9. A flexible six-axis force/torque sensing method based on the U-shaped micro/nanofiber, wherein the method is implemented through the flexible six-axis force/torque sensing device based on the U-shaped micro/nanofiber according to claim 1, and the method comprises:
inputting laser light to fiber input ends of the first U-shaped MNF, the second U-shaped MNF, the third U-shaped MNF, and the fourth U-shaped MNF; and
calculating three-axis forces and three-axis torques of optical signals at fiber output ends of the first U-shaped MNF, the second U-shaped MNF, the third U-shaped MNF, and the fourth U-shaped MNF after a force/torque is applied to the boss.

10. The flexible six-axis force/torque sensing method based on the U-shaped micro/nanofiber according to claim 9, wherein the three-axis forces and the three-axis torques are calculated according to the following formulas:
$${F}_{x} = {f}_{1} ( Δ {I}_{3} )$$
$${F}_{y} = {f}_{2} ( Δ {I}_{4} )$$
$${F}_{z} = {f}_{3} ( \frac{Δ {I}_{1} + Δ {I}_{2}}{2} )$$
$${M}_{x} = {f}_{4} ( Δ {I}_{1} )$$
$${M}_{y} = {f}_{5} ( Δ {I}_{2} )$$
$${M}_{z} = {f}_{6} ( \frac{Δ {I}_{3} + Δ {I}_{4}}{2} )$$
wherein Fₓ and F_{y}, F_{z} respectively denote force components of the three-axis forces in x, y and z directions; Mₓ, M_{y} and M_{z} respectively denote components of the three-axis torques in the x, y and z directions; ƒ₁, ƒ₂, ƒ₃, ƒ₄, ƒ₅ and ƒ₆ respectively denote relationship functions between Fₓ, F_{y}, F_{z}, Mₓ, M_{y}, M_{z} and changes in optical intensity; ΔI₁=I₁−I₁₀, ΔI₂=I₂−I₂₀, ΔI₃=I₃−I₃₀ and ΔI₄=I₄−I₄₀ respectively denote changes in optical intensities of the first U-shaped MNF, the second U-shaped MNF, the third U-shaped MNF, and the fourth U-shaped MNF when the force is applied; I₁₀, I₂₀, I₃₀ and I₄₀ respectively denote optical intensities at the fiber output ends of the first U-shaped MNF, the second U-shaped MNF, the third U-shaped MNF, and the fourth U-shaped MNF when no force is applied; and I₁, I₂, I₃ and I₄ respectively denote optical intensities at the fiber output ends of the first U-shaped MNF, the second U-shaped MNF, the third U-shaped MNF, and the fourth U-shaped MNF when the force is applied.
